(19) United States
(12) Patent Application Publication
(10) Pub. No.: US 2025/0052970 A1
(43) Pub. Date: Feb. 13, 2025

(54) OPTICAL FIBER CABLE INCLUDING OPTICAL FIBERS ORGANIZED INTO LUMENS FOR IDENTIFICATION

(71) Applicant: CORNING RESEARCH & DEVELOPMENT CORPORATION, Corning, NY (US)

(72) Inventors: Bradley Jerome Blazer, Granite Falls, NC (US); David Wesley Chiasson, Edmonton (CA); Michael John Gimblet, Conover, NC (US); Leigh Rooker Josey, Hickory, NC (US); Corey Scott Keisler, Conover, NC (US); Warren Welborn McAlpine, Hickory, NC (US); David Alan Seddon, Hickory, NC (US); Kenneth Darrell Temple, JR., Newton, NC (US)

(21) Appl. No.: 18/930,031

(22) Filed: Oct. 29, 2024

Related U.S. Application Data
(63) Continuation of application No. PCT/US2023/020562, filed on May 1, 2023.
(60) Provisional application No. 63/339,036, filed on May 6, 2022.

(51) Int. Cl. G02B 6/44

(52) U.S. Cl. CPC G02B 6/4434; G02B 6/4432; G02B 6/4486

(57) ABSTRACT

Embodiments of the disclosure relate to an optical fiber subunit. The optical fiber subunit includes a buffer tube having an interior surface and an exterior surface in which the interior surface defines a channel. The optical fiber subunit also includes a first lumen disposed within the channel. The first lumen includes a first membrane having a thickness of 0.15 mm or less and surrounds a first plurality of optical fibers. A second plurality of optical fibers disposed within the channel and outside the first lumen. Also disclosed are embodiments of an optical fiber cable having one or more lumens disposed within a central bore of a cable jacket and embodiments of a method of manufacturing an optical fiber cable.

### CROSS-REFERENCE TO RELATED APPLICATIONS

This application is a continuation of International Application No. PCT/US2023/020562, filed May 1, 2023, which claims the benefit of priority of U.S. Provisional Application No. 63/339,036 filed on May 6, 2022, the content of which is relied upon and incorporated herein by reference in its entirety.

### BACKGROUND

The disclosure relates generally to optical fiber cables and, in particular, to optical fiber cables having optical fibers organized into identifiable groups. Optical fibers are used to carry data throughout a telecommunications network. In general, there is a demand for higher speeds and larger capacities, which generally corresponds to a need for optical fiber cables containing more optical fibers. With an increased number of optical fibers in an optical fiber cable, organizing and identifying the optical fibers for routing data within the network accurately becomes an important consideration. Separating groups of optical fibers into buffer tubes or organizing them into ribbons is not always feasible, especially when trying to provide a compact cable size and high fiber densities.

### SUMMARY

According to an aspect, embodiments of the disclosure relate to an optical fiber subunit. The optical fiber subunit includes a buffer tube having an interior surface and an exterior surface in which the interior surface defines a channel. The optical fiber subunit also includes a first lumen disposed within the channel. The first lumen includes a first membrane having a thickness of 0.15 mm or less and surrounds a first plurality of optical fibers. A second plurality of optical fibers disposed within the channel and outside the first lumen.

According to another aspect, embodiments of the disclosure relate to an optical fiber cable. The optical fiber cable includes a cable jacket having an inner surface and an outer surface. The inner surface defines a central bore along a longitudinal axis of the optical fiber cable, and the outer surface defines an outermost surface of the optical fiber cable. A first lumen is disposed within the central bore, and the first lumen includes a first membrane having a thickness of 0.15 mm or less and surrounds a first plurality of optical fibers. A second plurality of optical fibers is disposed within the central bore and outside the first lumen.

According to a further aspect, embodiments of the disclosure relate to a method of manufacturing an optical fiber cable. In the method, a first membrane is extruded around a first plurality of optical fibers to form a first lumen. The first membrane has a thickness of 0.15 mm or less. Further, in the method, a jacket is extruded around the first lumen and around a second plurality of optical fibers such that the second plurality of optical fibers is outside of the first lumen.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a perspective view of an optical fiber cable including optical fibers arranged into lumens for organization and identification, according to an exemplary embodiment;

FIG. 2 depicts a cross-sectional view of the optical fiber cable of FIG. 1, according to exemplary embodiments;

FIG. 3 depicts a cross-sectional view of a first embodiment of a subunit including optical fibers arranged in two lumens, according to an exemplary embodiment;

FIG. 4 depicts a cross-sectional view of a second embodiment of a subunit including both loose optical fibers and optical fibers in a lumen, according to an exemplary embodiment;

FIG. 5 depicts a schematic of a processing line for applying a lumen to a group of optical fibers within a subunit, according to an exemplary embodiment; and

FIG. 6 depicts a cross-section of an extrusion die for forming two lumens around respective sets of optical fibers, according to an exemplary embodiment.

### DETAILED DESCRIPTION

Referring generally to the figures, various embodiments of an optical fiber cable having optical fibers organized into lumens for the purpose of identification are provided. As will be discussed more fully below, the organization of the optical fibers into lumens allows for identification of individual optical fibers from within large groups of optical fibers without requiring special marking of the optical fibers. For example, optical fibers are commonly color-coded in a sequence of twelve colors, and for subunits or cables including more than twelve optical fibers, the color coding needs to be modified to distinguish between groups of optical fibers. Conventionally, ring marking of the optical fibers is used to distinguish among optical fibers in a group of more than twelve optical fibers, but this identification system is limited in terms of the number of optical fibers that can be accommodated and does not work well with common cable division techniques. Further, the process of ring marking is slow and increases the cost of cable manufacturing. By arranging sets of optical fibers into lumens, the optical fibers can be color-coded using the standard twelve color scheme, and the lumens can be marked or colored to distinguish between the sets of optical fibers. Advantageously, the inventors do not expect that the lumens will significantly increase the cable or subunit size, and it is also believed that extruding the membranes of the lumens around the sets of optical fibers will not significantly decrease line speed or require processing on a separate processing line. Exemplary embodiments of the optical fiber cable including optical fibers organized in lumens will be described in greater detail below and in relation to the figures provided herewith, and these exemplary embodiments are provided by way of illustration, and not by way of limitation.

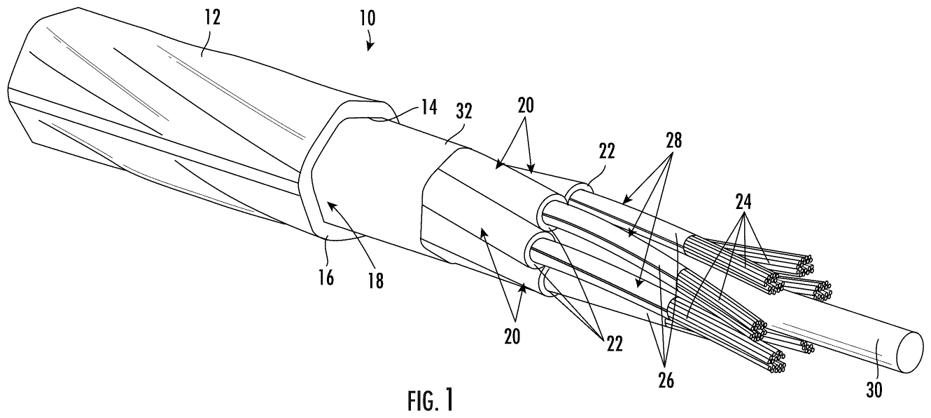

FIG. 1 depicts an embodiment of an optical fiber cable 10. The optical fiber cable 10 includes a cable jacket 12 having an inner surface 14 and an outer surface 16. In one or more embodiments, the outer surface 16 defines an outermost surface of the optical fiber cable 10. The outer surface 16 defines an outer shape of the cable jacker 12, and as can be seen in the embodiment depicted in FIG. 1, the outer shape is a rounded polygonal shape, in particular a rounded hexagonal shape. However, in one or more other embodiments, the outer shape may be other rounded polygonal or curved shapes, such as circular, discorectangular, square, triangular, pentagonal, or octagonal, among others. Further, as can be seen in the embodiment of FIG. 1, the sides of the outer shape of the cable jacket 12 may rotate positionally around the perimeter of the optical fiber cable 10 along a length of the optical fiber cable 10.

In one or more embodiments, the inner surface 14 defines a central bore 18. Disposed within the central bore 18 are a plurality of subunits 20. In the embodiment shown in FIG. 1, each subunit 20 is comprised of a buffer tube 22 and a plurality of optical fibers 24. Further, at least a portion of the plurality of optical fibers 24 of each subunit 20 are contained within a membrane 26 to form a lumen 28.

In one or more embodiments, the plurality of subunits 20 are stranded around a central strength member 30. For example, the plurality of subunits 20 may be SZ-stranded around the central strength member 30. In other embodiments, the plurality of subunits 20 may be helically stranded around the central strength member 30. As can be seen in FIG. 1, the outer shape of the cable jacket 12 may correspond to the number and the stranding of the plurality of subunits 20 disposed within the central bore 18. In particular, the cable jacket 12 may be tightly extruded around the subunits 20 so that that cable jacket 12 conforms to the shape of the stranded subunits 20. In one or more embodiments, the plurality of subunits 20 may be surrounded by a binder film 32 such that the binder film 32 is disposed between the buffer tubes 22 of each subunit 20 and the inner surface 14 of the cable jacket 12.

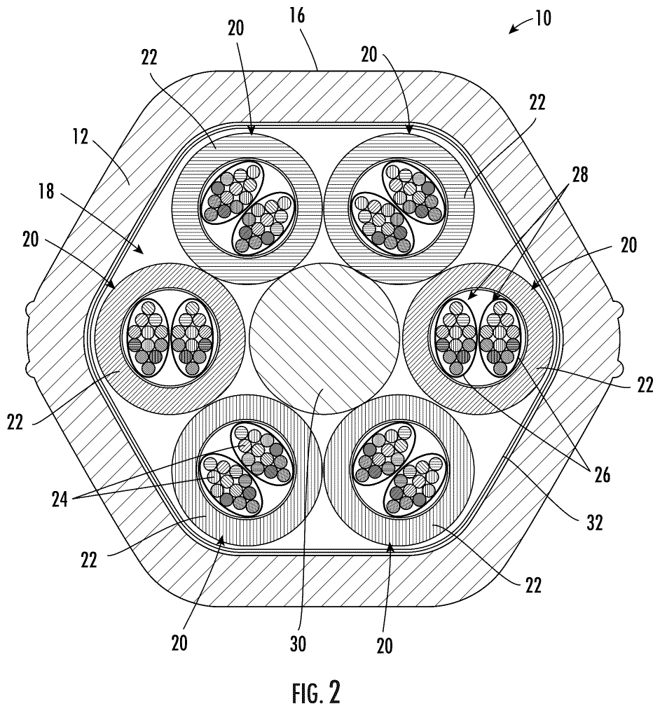

FIG. 2 depicts a cross-section of the optical fiber cable 10 of FIG. 1, and in the embodiment depicted in FIG. 2, it can be seen that each subunit 20 includes two lumens 28 with each lumen 28 containing half of the plurality of optical fibers 24. Thus, in one or more embodiments, including the embodiments depicted in FIGS. 1 and 2, all of the plurality of optical fibers 24 are contained within lumens 28. Advantageously, organizing the optical fibers 24 into lumens 28 helps to organize and identify the optical fibers within the subunit 20.

For the purposes of identification, each optical fiber may include an outer ink coating that identifies it from among a group of optical fibers. For example, twelve optical fibers may be provided in the commonly used color-coded identification sequence of blue, orange, green, brown, gray, white, red, black, yellow, violet, pink, and aqua. However, this sequence only allows for color coding of twelve optical fibers. For subunits or optical fiber cables that include more than twelve optical fibers, the sequence is typically repeated, but the optical fibers are further provided with ring markings. Thus, a first set of twelve optical fibers may be identified by the blue to aqua sequence, and a second set of optical fibers may be identified and distinguished from the first set by a blue to aqua sequence with the addition of one ring marking every interval (e.g., about 50 mm). A third set of optical fibers may be identified and distinguished from the first and second sets by a blue to aqua sequence with the addition of two ring markings every interval. In general, the maximum number of optical fibers that can be identified in this way is three sets having zero to two ring markings, and after two ring markings, the number of ring markings in a set becomes difficult to discern (i.e., adding a third ring marking may not allow for a handler to identify where one set of ring markings ends and another begins).

Besides the disadvantage in terms of the number of optical fibers that can be identified using ring markings, applying the ring markings to optical fibers adds expense to the cable manufacturing process. In particular, ring marking is typically done on a separate processing line, adding manufacturing steps and requiring additional material handling, and at speeds significantly slower than in-line processing speeds. Still further, ring marking does not work well with certain cable termination and division procedures in which a small window is cut into the cable jacket to access the optical fibers contained therein. Because of the interval between, ring marking sets, the small window may not coincide with a set of ring markings. Thus, the interval between ring markings would have to be made shorter, decreasing the ability to discern between sets of ring markings and slowing the manufacturing speeds to provide additional ring markings.

According to the present disclosure, the incorporation of at least some of the optical fibers 24 into lumens 28 allows for a new manner of organizing and identifying optical fibers 24 without the need for ring marking. In particular, in the embodiment shown in FIG. 2, the subunit 20 includes two lumens 28 within the buffer tube 22, and each lumen 28 includes twelve optical fibers 24. In this way, the optical fibers 24 can be color coded using the standard blue to aqua scheme, and the optical fibers 24 of each set are physically separated into different lumens 28.

The lumens 28 can be distinguished from each other in a variety of ways. For example, in one or more embodiments, the lumens 28 within each subunit 20 can be made in different colors or have stripes or ring markings to distinguish between lumens 28. While ring marking cannot be done with in-line processing of optical fibers, it can be done in-line with the lumens 28, and the inventors expect such ring marking would not or would not significantly affect line speed. Additionally, one or more differently colored stripes could be formed along the length of one or more of the lumens 28 by co-extruding a material of a different color within the membrane 26 of the lumen 28. Further, in one or more embodiments, each lumen 28 may be identified by printing text, barcodes, or other symbols onto each lumen 28. Such text, barcodes, or other symbols may be applied, e.g., through ink jet printing or laser printing. Still further, in or more embodiments, each lumen 28 may be translucent or transparent, and colored yarns or colored superabsorbent polymer (SAP) can be viewed through the translucent or transparent lumen 28. Because of the color or markings on the lumen 28, the buffer tube 22 of the subunit 20 may be uncolored such that only the lumens 28 and optical fibers 24 are colored in the optical fiber cable 10.

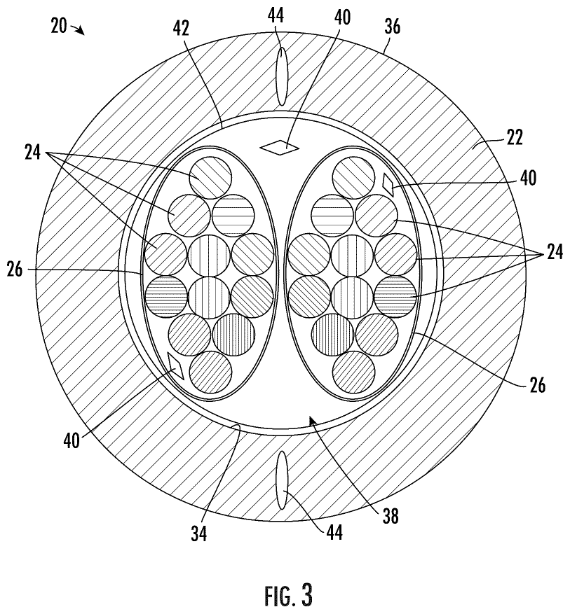

FIG. 3 depicts an example of a subunit 20 that can be included in the optical fiber cable 10 of FIGS. 1 and 2. In one or more embodiments, the buffer tube 22 of the subunit 20 has an interior surface 34 and an exterior surface 36. The interior surface 34 defines a channel 38. In the embodiment depicted in FIG. 3, two lumens 28 are disposed within the channel 38, and each lumen 28 includes twelve optical fibers 24. As discussed above, the optical fibers 24 of each lumen 28 may be color-coded according to the standard blue to aqua color scheme to distinguish among the optical fibers 24 within each lumen 28. To distinguish between lumens 28, the colors of the membranes 26 may be different, the membranes 26 may be marked with different features (e.g., stripes, ring markings, barcodes, words, symbols, etc.), and/or the membrane 26 may be transparent to view differently colored objects (such as a yarn or SAP) within the lumen 28.

In one or more embodiments, the optical fiber cable 10, in particular the subunits 20, are gel-free. That is, the optical fiber cable 10 and/or subunits 20 are not filled with any water-blocking gels. In one or more embodiments, at least one of the lumen 28 or the subunit 20 contains a water-blocking powder or yarn to provide water-blocking ability. For example, in one or more embodiments, water-blocking is provided by applying SAP powder into at least one of the membrane 26 of the lumen 28 or the buffer tube 22 of the subunit 20. In one or more embodiments, each lumen 28 includes a water-swellable yarn 40. In such embodiments, the yarn 40 may be impregnated with an SAP resin or SAP powder. In one or more embodiments, a water-swellable yarn 40 is located in the channel 38 outside of the lumens 28. In one or more embodiments, the interior surface 34 of the buffer tube 20 has a water-swellable coating 42, or the interior or exterior of the membrane 26 of the lumen 28 is coated with a water-swellable coating, or the optical fibers 24 is coated with a water-swellable coating. In one or more embodiments, the lumens 28 do not include a water-swellable yarn 40, powder, or coating, and the membrane 26 is provided with holes or is otherwise water permeable (e.g., made of an open cell foam material) to allow water to migrate from inside the lumen 28 to outside the lumen 28 for absorption by a water blocking feature disposed within the buffer tube 22.

FIG. 3 represents multiple features, including water-blocking features, of a subunit 20 and lumen 28, and in one or more embodiments, the subunit unit 20 and lumen 28 may contain some, all, or none of the water-blocking features depicted in FIG. 3.

In order to provide access to the lumens 28 within the subunit 20, the buffer tube 22 may include one or more access features 44. In one or more embodiments, the access features 44 are strips of dissimilar polymer within the buffer tube 22. For example, the buffer tube 22 may be a polyethylene material, and the access feature 44 may be a polypropylene material. The strip or strips of polypropylene weakly bond the polyethylene material of the buffer tube 22 such that the buffer tube 22 holds together but can be split apart into halves by hand. In one or more embodiments, the lumens 28 may be bonded to the interior surface 34 of the buffer tube 22 such that, upon splitting the buffer tube 22 at the access features 44, the lumens 28 separate with the halves of the buffer tube 22. In one or more embodiments, the lumens 28 can be bonded to the interior surface 34 of the buffer tube 22 using an adhesive material or by contacting the lumens 28 with the still hot extruded buffer tube 22.

Having described various embodiments of the optical fiber cable 10, including example embodiments of subunits 20, the construction of the lumen 28 is now further described. As mentioned, the lumen 28 is comprised of a thin membrane 26 that surrounds a plurality of optical fibers 24. Because of the difficulty in distinguishing between optical fibers 24 in a subunit 20 containing more than twelve optical fibers 24, the lumen 28 according to the present disclosure is employed primarily in subunits 20 or optical fiber cables 10 involving more than twelve optical fibers 24, in particular containing multiples of twelve optical fibers 24, such as twenty-four, thirty-six, forty-eight, sixty, etc. optical fibers 24. In one or more embodiments, the number of optical fibers 24 in each lumen 28 may be, e.g., two, three, four, six, or twelve optical fibers 24.

In one or more embodiments, the membrane 26 of the lumen 28 is thin and flexible. In particular, the membrane 26 has a thickness (i.e., distance between an interior and an exterior surface of the membrane 26) of 0.15 mm or less, in particular 0.1 mm or less, and most particularly 0.02 mm or less. In one or more embodiments, the membrane 26 has a thickness of 0.01 mm or more. For example, the membrane 26 may have a thickness in a range from 0.01 mm to 0.15 mm, 0.01 mm to 0.1 mm, 0.02 to 0.1 mm, or 0.02 to 0.05 mm. The thinness of the membrane 26 makes the membrane 26 flexible such that the lumen 28 is able to be reconfigured between a plurality of shapes to fit within the buffer tube 22. In one or more embodiments, the membrane 26 is comprised of a thermoplastic material, such as a polyester, a polypropylene, a polyamide, a polytetrafluoroethylene, or a polyethylene material. Further, in one or more embodiments, the material of the membrane 26 may be highly-filled with a filler material, such as chalk, clay, talc, or a flame retardant (e.g., alumina trihydrate or magnesium hydroxide), to enhance the tearability of the membrane 26 to provide case of access to the optical fibers 24.

In one or more embodiments, the free space within the lumen 28 is 50% or less. That is, the optical fibers 24 within the membrane 26 fill at least 50% of a cross-sectional area defined by the membrane 26. In one or more particular embodiments, the free space within the lumen 28 is 40% or less, 30% or less, 25% or less. Further, in one or more embodiments, the free space within the lumen 28 is at least 15% or at least 20%. In one or more embodiments, the free space within the lumen 28 may be influenced by the lubrication provided within the lumen 28 or within the subunit 20. In one or more embodiments, the lubrication may be in the form of a gel (except in “gel-free” embodiments), talc or other low friction materials, or coatings.

The interior surface 34 of the buffer tube 22 defines an inner diameter of the buffer tube 22, and the exterior surface 36 of the buffer tube 22 defines an outer diameter of the buffer tube 22. In one or more embodiments, the outer diameter of the buffer tube 22 is 4 mm or less. In one or more particular embodiments, the outer diameter of the buffer tube 22 is about 2.7 mm. In one or more embodiments, the inner diameter of the buffer tube 22 is at least 0.8 mm. In one or more particular embodiments, the inner diameter of the buffer tube 22 is about 1.8 mm. In one or more embodiments, the thickness of the buffer tube 22 (i.e., distance between the interior surface 34 and the exterior surface 36) is 1 mm or less, in particular 0.75 mm or less, and most particularly 0.5 mm or less.

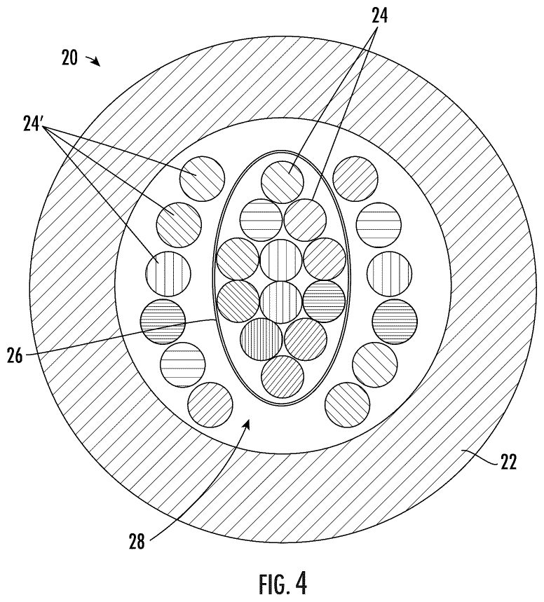

FIG. 4 depicts another embodiment of a subunit 20 in which the channel 38 of the buffer tube 22 includes a first plurality of optical fibers 24 disposed within a membrane 26 to form a lumen 28 and a second plurality of loose optical fibers 24′. That is, the second plurality of optical fibers 24′ are not contained within a membrane 26 to form a lumen 28. In this way, the sets of optical fibers 24, 24′ are distinguished based on whether or not the optical fibers 24, 24′ are contained in a lumen 28. For twenty-four optical fibers 24, 24′, only one lumen 28 is provided. For higher multiples of twelve optical fibers 24, 24′, only one set of the twelve optical fibers 24′ will be loose in the subunit 20, and the remaining sets of twelve optical fibers 24 will be contained within lumens 28. Besides including loose optical fibers 24′, the subunit 20 depicted in FIG. 4 may otherwise be incorporated into an optical fiber cable 10 as shown in FIGS. 1 and 2.

While the foregoing cable constructions incorporate subunits 20 stranded around a central strength member 30, other cable constructions involving the use of lumens 28 for identification of the optical fibers 24 are possible. For example, the optical fiber cable may be a drop cable with or without a buffer tube 22. In embodiments in which the optical fiber cable 10 does not include subunits 20, the lumens 28 may be disposed within the central bore 18 of the cable jacket 12. Further, the cable construction may not have a central strength member 30 and may instead have strength members embedded in the cable jacket.

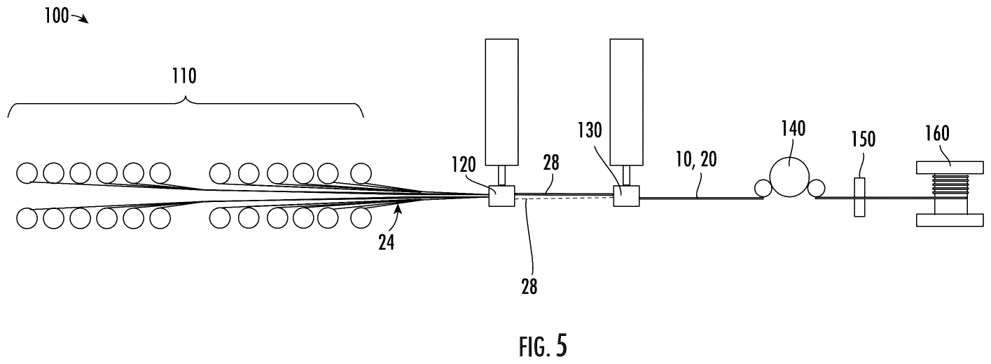

FIG. 5 depicts an example embodiment of a process line 100 for manufacturing a subunit 20, such as the subunits shown in FIGS. 3 and 4, or an optical fiber cable 10. As shown in the embodiment of FIG. 5, the process line 100 includes a plurality of optical fiber payoff reels 110. A payoff reel 110 is provided for each optical fiber 24 in the subunit 20. The optical fibers 24 are arranged into a number of sets, in particular sets of twelve optical fibers 24. If a yarn 40, such as a water-swellable yarn or ripcord, is included within the lumen 28, then additional payoff reels may be provided for such a yarn 40 for each set of optical fibers 24.

In the embodiment of FIG. 5, there are two sets of twelve optical fibers 24. The sets of optical fibers 24 are directed through a first extruder 120 to form the membrane 26 around the optical fibers 24 to create lumens 28. As discussed above, one set of optical fibers 24 can be surrounded by a membrane 26 to form a lumen 28, and the other set of optical fibers may be loose optical fibers 24′ around which no membrane 26 is extruded. Thereafter, the lumens 28 (or lumen 28 and loose optical fibers 24′) are directed through a second extruder 130, which extrudes a buffer tube 22 or cable jacket 12 around the lumens 28 (or lumen 28 and loose optical fibers 24′) to form the subunit 20 or optical fiber cable 10. The spacing between first extruder 120 and the second extruder 130 can be configured to provide requisite cooling of the membrane 26 of the lumens 28 before application of the buffer tube 22 or cable jacket 12. Additionally, if the lumens 28 are provided with distinguishing markings, the space between the first extruder 120 and the second extruder 130 can contain a marking device configured to print or apply stripes, ring markings, barcodes, symbols, text, etc. to the lumens 28. For example, a laser printer or inkjet printer can be arranged between the first extruder 120 and the second extruder 130.

In one or more embodiments, the subunit 20 or optical fiber cable 10 is cooled for a distance before running through a capstan 140. The capstan 140 provides consistent pulling force on the line to maintain desired line speeds. After the capstan 140, the subunit 20 or optical fiber cable 10 may proceed through a gauge or gauges 150 to verify the dimensions and quality of the extruded buffer tube 22 or cable jacket 12. Thereafter, the subunit 20 or optical fiber cable 10 is spooled on a takeup reel 160. Advantageously, the formation of the subunit 20 or optical fiber cable 10 is performed on a single line, and minimal modification of a conventional processing line is needed. In particular, the incorporation of the first extruder 120 for forming the lumens 28 is substantially the only modification of the process for forming the subunit 20 or the optical fiber cable 10. Line speeds are maintained, and no offline marking is required to distinguish between the optical fibers 24.

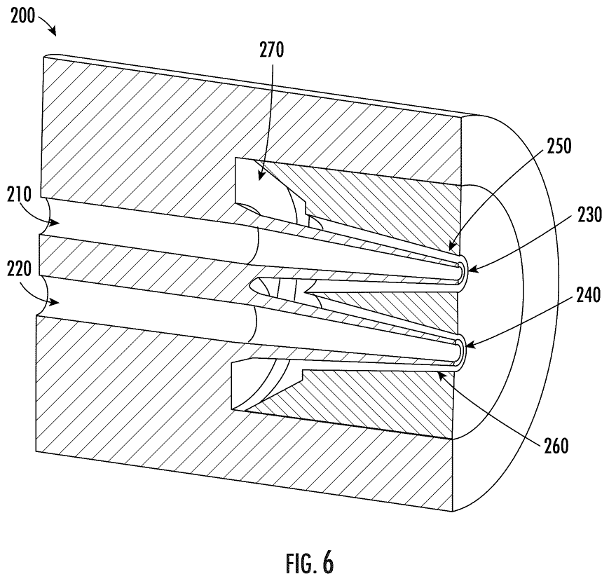

FIG. 6 depicts an example embodiment of an extrusion die 200 for the first extruder 120 that is capable of simultaneously forming membranes 26 for two lumens 28 around two sets of optical fibers 24. As shown in FIG. 6, the extrusion die 200 includes a first through channel 210 and a second through channel 220. A first set of optical fibers 24 proceeds through the first through channel 210, and a second set of optical fibers 24 proceeds through the second through channel 220. The first through channel 210 includes a first tapered region 230, and the second through channel 210 includes a second tapered region 240. In the tapered regions 230, 240, the inner diameter of the through channels 210, 220 decreases. A first nozzle 250 is formed around the first tapered region 230, and a second nozzle 260 is formed around the second tapered region 240. Molten polymer is directed through each nozzle 250, 260 to form membranes 26 around the respective sets of optical fibers 24 emerging from the respective through channels 210, 220. Each nozzle 250, 260 is in fluid communication with a reservoir 270 of molten polymer material. Where the membranes 26 are the same color (e.g., where other distinguishing markings are applied to the membrane 26 or contained within the membrane 26), the reservoir 270 may be common to each nozzle 250, 260 as shown in FIG. 6. However, if the membranes 26 are different colors, then two separate reservoirs 270 may be provided.

Optical fiber cables 10 and subunits 20 as described herein have several advantages. Particularly, the optical fiber cable 10 and subunits 20 overcome the drawbacks of the conventional system and process of ring marking optical fibers for identification, including the increased cost and slow processing, incompatibility with certain methods of cable division, and limited applicability to large numbers of optical fibers. The advantages in terms of cost and processing speeds have been discussed above. With respect to cable division methods, the optical fibers 24 can be identified anywhere along the length of the cable 10 such that the small access window can be placed anywhere along the length of the cable 10. Additionally, the membrane 26 of the lumen 28 may act as a furcation tube during cable division.

Still further, while the lumens 28 are particularly suitable for cables having multiples of twelve optical fibers 24, the lumens 28 can be used to group any number of optical fibers 24 within a subunit 20 or cable 10 having more than twelve optical fibers 24. For example, a particular customer may have a requirement to arrange optical fibers 24 into groups of eight. Two groups of eight is sixteen optical fibers 24, which provides the same difficulty of distinguishing among more than twelve optical fibers 24. Accordingly, the optical fibers 24 can be placed into lumens 28 containing the desired eight optical fibers 24 using the standard color code to distinguish between individual optical fibers 24 within the lumens 28 and differences in marking, color, or levels of transparency to distinguish between the lumens 28.

The lumens 28 also provide an additional way to introduce sufficient strain window into the cable design. In particular, the optical fibers 24 going in the lumens 28 can be twisted or stranded, including rigidly or SZ-stranded, or the lumens 28 in the buffer tube 22 of the subunit 20 can be twisted or stranded, including rigidly or SZ-stranded. Thus, besides providing a convenient means of identification, the construction of the optical fiber cable 10, including the grouping of one or more sets of optical fibers 24 into lumens 28 provides other advantages no provided by conventional means of identification, such as ring marking.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art. the disclosed embodiments should be construed to include everything within the scope of the appended claims and their equivalents.

What is claimed is:

1. An optical fiber subunit, comprising:
a buffer tube comprising an interior surface and an exterior surface, the interior surface defining a channel;
a first lumen disposed within the channel, the first lumen comprising a first membrane having a thickness of 0.15 mm or less and surrounding a first plurality of optical fibers;
a second plurality of optical fibers disposed within the channel and outside the first lumen.

2. The optical fiber subunit of claim 1, wherein the second plurality of optical fibers is surrounded by a second membrane having a thickness of 0.15 mm or less to form a second lumen.

3. The optical fiber subunit of claim 2, wherein the first lumen is distinguished from the second lumen by at least one of color, markings, or level of transparency.

4. The optical fiber subunit of claim 3, wherein the first lumen is transparent or translucent and the first membrane surrounds a colored water-swellable yarn or a colored superabsorbent polymer.

5. The optical fiber subunit of claim 3, wherein the first membrane of the first lumen is marked with at least one of a stripe, a ring marking, a barcode, text, or symbols that distinguish the first lumen from the second lumen.

6. The optical fiber subunit of claim 1, wherein the second plurality of optical fibers are loose within the channel of the buffer tube.

7. The optical fiber subunit of claim 1, wherein the first membrane defines a cross-sectional area and wherein the first plurality of optical fibers occupies at least 50% of the cross-sectional area.

8. The optical fiber subunit of claim 1, wherein the first membrane comprises a thickness in a range of 0.01 mm to 0.1 mm.

9. The optical fiber subunit of claim 1, wherein the first membrane comprises an open cell foam material.

10. The optical fiber subunit of claim 1, wherein the subunit comprises at least one of a water-swellable yarn disposed within the channel or a water-swellable polymer coating on the interior surface of the buffer tube and wherein the first lumen does not include a water-swellable component.

11. An optical fiber cable, comprising:
a cable jacket comprising an inner surface and an outer surface, the inner surface defining a central bore along a longitudinal axis of the optical fiber cable and the outer surface defining an outermost surface of the optical fiber cable;
a first lumen disposed within the central bore, the first lumen comprising a first membrane having a thickness of 0.15 mm or less and surrounding a first plurality of optical fibers;
a second plurality of optical fibers disposed within the central bore and outside the first lumen.

12. The optical fiber cable of claim 11, further comprising a first subunit comprising a first buffer tube, wherein the first lumen and the second plurality of optical fibers are disposed within the first buffer tube.

13. The optical fiber cable of claim 12, wherein the second plurality of optical fibers are surrounded by a second membrane having a thickness of 0.15 mm or less to form a second lumen and wherein the second lumen is disposed within the first buffer tube.

14. The optical fiber cable of claim 13, wherein the first lumen is distinguished from the second lumen by at least one of color, markings, or level of transparency.

15. The optical fiber cable of claim 11, further comprising a central strength member and a plurality of subunits disposed within the central bore, the plurality of subunits being stranded around the central strength member, and wherein the first lumen and the second plurality of optical fibers are disposed within a subunit of the plurality of subunits.

16. A method of manufacturing an optical fiber cable, comprising:
extruding a first membrane around a first plurality of optical fibers to form a first lumen, wherein the first membrane has a thickness of 0.15 mm or less;
extruding a jacket around the first lumen and around a second plurality of optical fibers such that the second plurality of optical fibers is outside of the first lumen.

17. The method of claim 16, further comprising extruding a second membrane around the second plurality of optical fibers, the second membrane having a thickness of 0.15 mm or less, wherein extruding the second membrane is performed before extruding the jacket.

18. The method of claim 17, wherein extruding the second membrane is performed simultaneously with extruding the first membrane and wherein the first membrane and the second membrane are extruded through a same extrusion die.

19. The method of claim 16, wherein the jacket is a buffer tube.

20. The method of claim 16, wherein the jacket is a cable jacket comprising an inner surface and an outer surface, the outer surface being an outermost surface of the optical fiber cable.
